(19) United States
(12) Patent Application Publication
(10) Pub. No.: US 2026/0005602 A1
(43) Pub. Date: Jan. 1, 2026

(54) COUPLED INDUCTOR ASSEMBLY

(71) Applicant: Monolithic Power Systems, Inc., Kirkland, WA (US)

(72) Inventors: Ting GE, San Jose, CA (US); Gang WANG, Plano, TX (US)

(21) Appl. No.: 19/239,935

(22) Filed: Jun. 16, 2025

Related U.S. Application Data
(60) Provisional application No. 63/665,544, filed on Jun. 28, 2024.

(51) Int. Cl. H02M 3/00; H01F 27/24; H01F 27/29; H02M 3/155

(52) U.S. Cl. CPC H02M 3/003; H01F 27/24; H01F 27/29; H02M 3/155

(57) ABSTRACT

An inductor assembly comprises a first pin, a second pin, a third pin, a fourth pin, a magnetic core, a first winding and a second winding. The first winding has a first portion extended to form the first pin, a second portion extended to form the fourth pin, and a third portion. The second winding has a fourth portion extended to form the second pin, a fifth portion extended to form the third pin, and a sixth portion at least partially over-lapped with the third portion. The third portion and the sixth portion wrap around a center leg of the magnetic core. The first pin and the second pin are at a first side of the inductor assembly, the third pin and the fourth pin are at a second side of the inductor assembly which opposites the first side.

### CROSS-REFERENCE TO RELATED APPLICATIONS

The present application claims the benefit of U.S. Provisional Application No. 63/665,544, filed on Jun. 28, 2024, which is incorporated herein by reference in its entirety.

### BACKGROUND OF THE INVENTION

### 1. Field of the Invention

The present invention generally relates to electrical components, and more particularly but not exclusively relates to inductor assembly.

### 2. Description of Related Art

Power converter, as known in the art, converts an input power to an output power for providing a load with required voltage and current. Multi-phase power converter comprising a plurality of paralleled power stages operating out of phase has lower output ripple voltage, better transient performance and lower ripple-current-rating requirements for input capacitors. They are widely used in high current and low voltage applications, such as server and microprocessor.

With the development of modern GPUs (Graphics Processing Units), and CPUs (Central Processing Units), increasingly high load current is required to achieve better processor performance. However, higher current and smaller size put more challenges to the heat conduction. Therefore, it is desirable to provide a power module with high-power density, high-efficiency and excellent heat dissipation capability in space-constrained environments.

### SUMMARY

In one embodiment, an inductor assembly comprises a first pin, a second pin, a third pin, a fourth pin, a magnetic core, a first winding and a second winding. The magnetic core has a first core part, wherein the first core part has a center leg. The first winding has a first portion, a second portion and a third portion. The first portion extends to a first side of the inductor assembly to form the first pin, the second portion extends to a second side of the inductor assembly to form the fourth pin, the second side opposites the first side. The second winding has a fourth portion, a fifth portion and a sixth portion. The fourth portion extends to the first side of the inductor assembly to form the second pin, the fifth portion extends to the second side of the inductor assembly to form the third pin, the sixth portion is at least partially over-lapped with the third portion. The third portion and the sixth portion wrap around the center leg.

In another embodiment, a switching converter comprises a first pair of switches, a second pair of switches, and an inductor assembly. The inductor assembly has a first input pin, a second input pin, a first output pin, and a second output pin. The first input pin is coupled to a first switch node formed by the first pair of switches, and the second input pin is coupled to a second switch node formed by the second pair of switches. The inductor assembly comprises a first winding, a second winding, and a magnetic core. The first winding has a first portion, a second portion and a third portion. The first portion extends to form the first input pin, the second portion extends to form the first output pin. The second winding has a fourth portion, a fifth portion and a sixth portion. The fourth portion extends to form the second input pin, the fifth portion extends to form the second output pin, and the sixth portion is at least partially over-lapped with the third portion. The magnetic core has a center leg wrapped around by the third portion and the sixth portion.

These and other features of the present disclosure will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals. These drawings are only for illustration purpose, thus may only show part of the devices and are not necessarily drawn to scale.

FIG. 1 shows a schematic diagram of a switching converter 100 in accordance with an embodiment of the present invention.

FIG. 2A shows a front view of an inductor assembly 200 in accordance with an embodiment of the present invention.

FIG. 2B shows the magnetic flux of the inductor assembly 200 in accordance with an embodiment of the present invention.

FIG. 3 shows a top view of a core part 203-1 and associated windings of the inductor assembly 200 of FIG. 2 and associated schematic symbol in accordance with an embodiment of the present invention.

FIG. 4A shows a front view of an inductor assembly 400 in accordance with an embodiment of the present invention.

FIG. 4B shows a top view of a core part 403-1 and associated windings of the inductor assembly 400 of FIG. 4A and associated schematic symbol in accordance with an embodiment of the present invention.

FIG. 5 shows a disassembled view 500 of the windings 411 and 412 of the inductor assembly 400 of FIG. 4 in accordance with an embodiment of the present invention.

FIG. 6 shows an inductor assembly 600 in accordance with an embodiment of the present invention.

FIG. 7 shows a disassembled view of the inductor assembly 600 of FIG. 6 in accordance with an embodiment of the present invention.

FIG. 8 shows a bottom view of the inductor assembly 600 of FIG. 6 in accordance with an embodiment of the present invention.

FIG. 9 shows a side view of the inductor assembly 600 of FIG. 6 in accordance with an embodiment of the present invention.

FIG. 10 shows a top and perspective view of the inductor assembly 600 of FIG. 6 in accordance with an embodiment of the present invention.

FIG. 11 shows a top and disassembled view of the windings 611-612, the core parts 603-1 and 603-2 of the inductor assembly 600 of FIG. 6 in accordance with an embodiment of the present invention.

FIG. 12 shows the windings 611 and 612 in accordance with an embodiment of the present invention.

FIGS. 13-14 show side views of the windings 611 and 612 of FIG. 12 in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

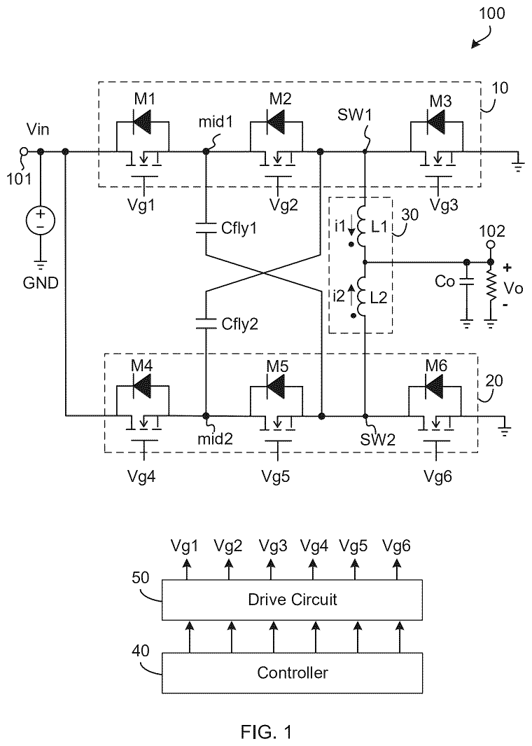

FIG. 1 shows a schematic diagram of a switching converter 100 in accordance with an embodiment of the present invention. The switching converter 100 receives an input voltage Vin at an input terminal 101 and provides an output voltage Vo at an output terminal 102. The switching converter 100 has a coupled inductor assembly 30 having an inductor L1 and an inductor L2 which are reversely coupled. The inductor L1 has a first end coupled to a switching node SW1 formed by a first pair of switches (e.g., M2 and M3), and a second end coupled to the output terminal 102. The inductor L2 has a first end coupled to a switching node SW2 formed by a second pair of switches (e.g., M5 and M6), and a second end coupled to the output terminal 102. In operation, a current i1 flows through the inductor L1 and a current i2 flows through the inductor L2 as shown in FIG. 1. The inductor assembly 30 could reduce the current ripple while maintaining fast transient response.

In the example of FIG. 1, the switching converter 100 is a hybrid buck converter which comprises a switching circuit 10 having the first pair of switches, a switching circuit 20 having the second pair of switches, a flying capacitor Cfly1, a flying capacitor Cfly2, and the inductor assembly 30. The inductor assembly 30 has two inductors L1 and L2 which are reversely coupled. One with ordinary skill in the art should understand that the switching converter 100 may also use other topology.

As shown in FIG. 1, the switching circuit 10 has three switches M1-M3 coupled in series between the input terminal 101 and a reference ground GND. A first end of the switch M1 is coupled to the input terminal 101, a second end of the switch M1 is coupled to a first end of the switch M2 to form an intermediate node mid1. A second end of the switch M2 is coupled to a first end of the switch M3 to form the switching node SW1, and a second end of the switch M3 is coupled to the reference ground GND. The switching circuit 20 has three switches M4-M6 coupled in series between the input terminal 101 and the reference ground GND. A first end of the switch M4 is coupled to the input terminal 101, a second end of the switch M4 is coupled to a first end of the switch M5 to form an intermediate node mid2. A second end of the switch M5 is coupled to a first end of the switch M6 to form the switching node SW2, and a second end of the switch M6 is coupled to the reference ground GND.

The switches M1-M6 may comprise MOSFET, Junction Field Effect Transistor (JFET), and other suitable transistor. In the example of FIG. 1, each of the switches M1-M6 is a MOSFET, the first end of each of the switches M1-M6 is a drain, and the second end of each of the switches M1-M6 is a source. A control end of each of the switches M1-M6 is a gate, which may receive a corresponding driving signal in accordance with a control scheme to control the operation of the switching converter 100 of FIG. 1 to generate the output voltage Vo.

The flying capacitor Cfly1 is coupled between the intermediate node mid1 and the switching node SW2. For example, a first end of the flying capacitor Cfly1 is coupled to the intermediate node mid1, and a second end of the flying capacitor Cfly1 is coupled to the switching node SW2. The flying capacitor Cfly2 is coupled between the intermediate node mid2 and the switching node SW1. For example, a first end of the flying capacitor Cfly2 is coupled to the intermediate node mid2, and a second end of the flying capacitor Cfly2 is coupled to the switching node SW1.

As shown in FIG. 1, the switching converter 100 further comprises a controller 40. The controller 40 is configured to provide drive signals Vg1-Vg6 to drive the switches M1-M6 respectively via a drive circuit 50. The controller 40 could adopt suitable control scheme to generate the drive signals Vg1-Vg6.

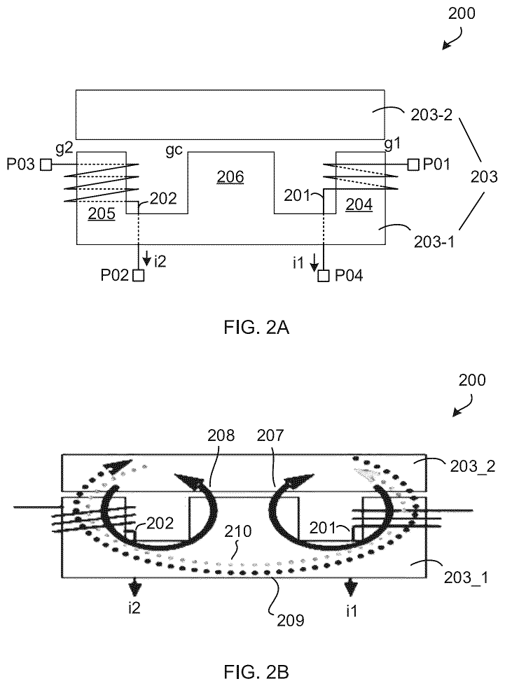

FIG. 2A shows a front view of an inductor assembly 200 in accordance with an embodiment of the present invention. The inductor assembly 200 is a specific implementation of the inductor assembly 30 shown in FIG. 1. In the example of FIG. 2A, the inductor assembly 200 comprises four pins P01-P04, two windings 201 and 202, and a magnetic core 203. The magnetic core 203 has a core part 203-1 and a core part 203-2. In the example of FIG. 2A, the core part 203-1 has an E-shape and the core part 203-2 has a planar shape. However, one with ordinary skill in the art should also understand that the core parts 203-1 and 203-2 could have other suitable shapes. The core part 203-1 has three legs 204, 205 and 206. The leg 206 is a center leg positioned between the leg 204 and the leg 205. In the example shown in FIG. 2A, a gap g1 is formed between the leg 204 of the core part 203-1 and the core part 203-2, a gap g2 is formed between the leg 205 of the core part 203-1 and the core part 203-2, and a gap gc is formed between the leg 206 of the core part 203-1 and the core part 203-2.

Furthermore, the winding 201 wraps around the leg 204 of the core part 203-1, and the winding 202 wraps around the leg 205 of the core part 203-1. As shown in FIG. 2A, the windings 201 and 202 of the inductor assembly 200 are arranged as inversely coupled to achieve fast transient response and small current ripple at steady state. Two ends of the winding 201 form the pins P01 and P04 respectively, and two ends of the winding 202 form the pins P02 and P03 respectively as shown in FIG. 2A. In the example shown in FIG. 2A, the current i1 flows into the winding 201 via the pin P01, and output from the winding 201 via the pin P04, the current i2 flows into the winding 202 via the pin P03 and output from the winding 202 via the pin P02.

FIG. 2B shows the magnetic flux of the inductor assembly 200 in accordance with an embodiment of the present invention. A curve 207 indicates a leakage inductance of the winding 201, a curve 208 indicates a leakage inductance of the winding 202, a curve 209 indicates a mutual inductance of the winding 201 to the winding 202, and a curve 210 indicates a mutual inductance of the winding 202 to the winding 201.

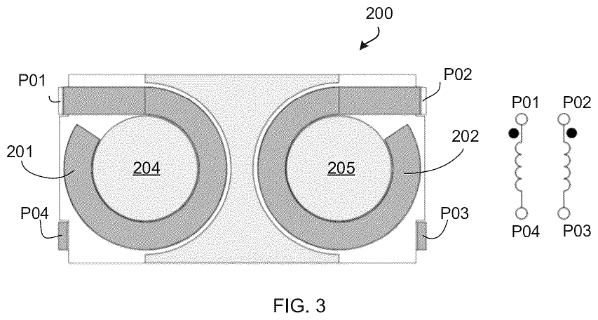

FIG. 3 shows a top view of a core part 203-1 and associated windings of the inductor assembly 200 of FIG. 2 and associated schematic symbol in accordance with an embodiment of the present invention.

In one embodiment, the pins P01 and P03 are current input pins, and the pins P02 and P04 are current output pins. To achieve inverse coupling of the windings 201 and 202, the current output pins P02 and P04 should be connected. However, as shown in FIG. 3, the current output pins P02 and P04 are not positioned at the same side of the inductor assembly 200, which results in additional routing of a copper trace and a resistance in the current path, then additional loss is introduced. In another embodiment, the pins P01 and P03 act as the current output pins, and the pins P02 and P04 act as the current input pins. Connecting the pins P01 and P03 to achieve inverse coupling would introduce additional loss too. Moreover, in the configuration shown in FIGS. 2-3, the magnetic flux generated by two windings adds up in the center leg 206, leading to higher core loss due to higher flux density in the center leg 206.

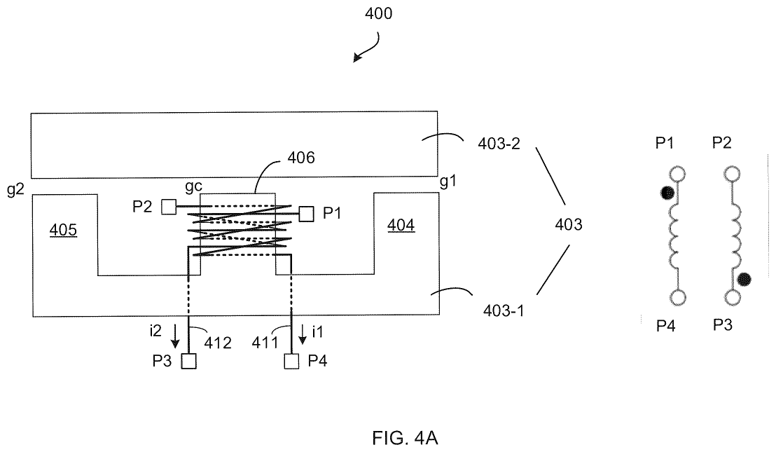

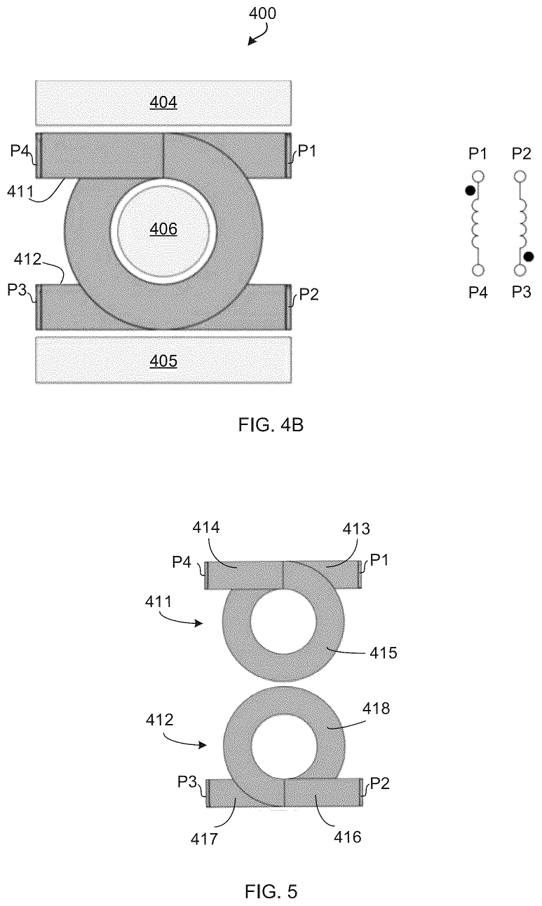

FIG. 4A shows a front view of an inductor assembly 400 in accordance with an embodiment of the present invention. The inductor assembly 400 is a specific implementation of the inductor assembly 30 shown in FIG. 1.

In the example of FIG. 4A, the inductor assembly 400 comprises four pins P1-P4, two windings 411 and 412, and a magnetic core 403. The magnetic core 403 has a core part 403-1 and a core part 403-2. In the example of FIG. 4A, the core part 403-1 has an E-shape and the core part 403-2 has a planar shape. However, one with ordinary skill in the art should also understand that the core parts 403-1 and 403-2 could have other suitable shapes, for example both of core parts may be E-shapes. The core part 403-1 has a center leg 406, and two outer legs 404 and 405. The center leg 406 is positioned between the outer legs 404 and 405. The core part 403-2 faces towards the center leg 406 and the outer legs 404-405 of the core part 403-1.

Furthermore, the windings 411 and 412 wrap around the center leg 406, and the windings 411 and 412 are arranged as inversely coupled to achieve fast transient response and small current ripple at steady state. Two ends of the winding 411 form the pins P1 and P4 respectively, and two ends of the winding 412 form the pins P2 and P3 respectively. In one example, the pins P1 and P2 are configured as two input pins of the inductor assembly 400, the pins P3 and P4 are configured as two output pins of the inductor assembly 400. The pin P1 is coupled to a first switching node formed by a first pair of switches (e.g., SW1 in FIG. 1), the pin P2 is coupled to a second switching node formed by a second pair of switches (e.g., SW2 in FIG. 1). The pins P3 and P4 are coupled together to provide the output voltage Vo at the output terminal 102. In another example, the pin P3 is coupled to a first output terminal to provide a first output voltage, and the pin P4 is coupled to a second output terminal to provide a second output voltage. In the example shown in FIG. 4A, the current i1 flows into the winding 411 via the pin P1, and output from the winding 411 via the pin P4, the current i2 flows into the winding 412 via the pin P2 and output from the winding 412 via the pin P3.

FIG. 4B shows a top view of a core part 403-1 and associated windings of the inductor assembly 400 of FIG. 4A and associated schematic symbol in accordance with an embodiment of the present invention.

In the example shown in FIG. 4B, two windings 411 and 412 are at least partially over-lapped, and the center leg 406 is wrapped around by the windings 411 and 412. The center leg 406 may have a circle shape, an oval shape, a racetrack shape, and so on. The outer legs 404 and 405 may have a rectangular shape. The pins P1 and P2 are positioned at a first side of the inductor assembly 400 as the current input pins, the pins P3 and P4 are positioned at a second side of the inductor assembly 400 which opposites the first side as the current output pins. The outer leg 404 is positioned along a third side, the outer leg 405 is positioned along a fourth side opposite the third side. The third side and the fourth side are perpendicular to the first side and the second side.

FIG. 5 shows a disassembled view 500 of the windings 411 and 412 in accordance with an embodiment of the present invention. As shown in FIG. 5, the winding 411 wraps around the center leg 406 in an anticlockwise direction, while the winding 412 wraps around the center leg 406 in a clockwise direction, such that the flux generated by two windings reduced in the center leg 406, which generally reduces the core loss. In another embodiment, the winding 411 may wrap in the clockwise direction, while the winding 412 may wrap in the anticlockwise direction.

As shown in FIG. 5, the winding 411 has portions 413-415. The portion 413 extends to the first side of the inductor assembly 400 to form the pin P1, the portion 414 extends to the second side of the inductor assembly 400 to form the pin P4. At least part of the portion 414 is beneath part of the portion 413 in a vertical direction of the inductor assembly 400. The portion 415 comprises at least a curved part. For example, the portion 415 may have the circle shape, the oval shape, the racetrack shape, and so on. The winding 412 has portions 416-418. The portion 416 extends to the first side of the inductor assembly 400 to form the pin P2, the portion 417 extends to the second side of the inductor assembly 400 to form the pin P3. At least part of the portion 416 is beneath part of the portion 417 in the vertical direction of the inductor assembly 400. The portion 418 comprises at least a curved part. For example, the portion 418 may have the circle shape, the oval shape, the racetrack shape, and so on. In the example of FIG. 5, the portions 415 and 418 are circle shape. The portion 418 is over-lapped with the portion 415, and the center leg 406 is wrapped around by the portions 415 and 418.

The winding configuration shown in FIGS. 4-5 allows the pins P1 and P2 that currents input from are on the same side of the inductor assembly 400, and also allows the pins P3 and P4 that currents output from are on the same side of the inductor assembly 400, which makes the route straight and no extra path for currents, then improves the efficiency of the switching converter 100. In addition, in the winding configuration shown in FIGS. 4-5, the flux generated by two windings 411 and 412 at least partially cancelled with each other in the center leg 406 of the magnetic core 403, which generally reduces the core loss. This configuration also allows to use two different core materials to further improve the saturation characteristics and increases the current rating without increasing the cost dramatically. Due to the flux reduction in the center leg 406, a cost-effective material (e.g., ferrite, high-u powder iron) with lower saturation point can be used to form the center leg 406, while another material (e.g., normal powder iron) with higher saturation point can be used to form the two outer legs 404 and 405, to utilize the benefit of reduced DC flux density at the center leg 406.

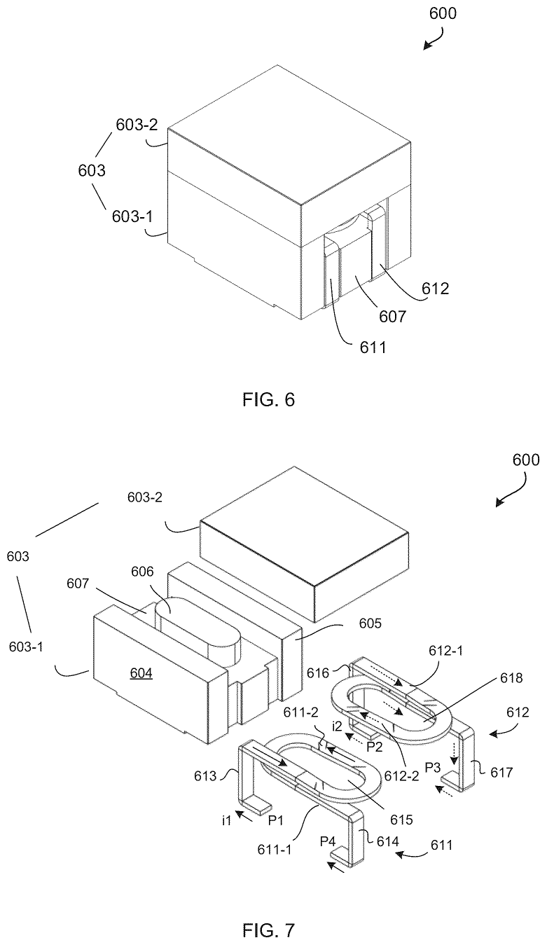

FIG. 6 shows an inductor assembly 600 in accordance with an embodiment of the present invention. The inductor assembly 600 is a specific implementation of the inductor assembly 30 shown in FIG. 1. The inductor assembly 600 has a magnetic core 603, two windings 611 and 612, and four pins P1-P4 (as shown in FIG. 7). The magnetic core 603 has a core part 603-1 and a core part 603-2.

FIG. 7 shows a disassembled view of the inductor assembly 600 of FIG. 6 in accordance with an embodiment of the present invention.

In the example of FIG. 7, the core part 603-1 has the E-shape- and the core part 603-2 has the planar shape. However, one with ordinary skill in the art should also understand that the core parts 603-1 and 603-2 could also have other suitable shapes, such as EE core, EC core, ETD core, or PQ core. The core part 603-1 has a center leg 606, two outer legs 604-605, and a yoke 607. The yoke 607 connects the center leg 606 with the outer legs 604-605. In one embodiment, top surfaces of the center leg 606 and two outer legs 604-605 are on a same plane, having a same height in the vertical direction of the inductor assembly 600, and bottom surfaces of the yoke 607 and the outer legs 604 and 605 are on a bottom surface of the inductor assembly 600. The center leg 606 is positioned between the outer legs 604 and 605, and the center leg 606 is wrapped around by windings 611 and 612.

As shown in FIG. 7, the winding 611 has portions 613-615. The portion 613 extends to form the pin P1, the portion 614 extends to form the pin P4. The winding 612 has portions 616-618. The portion 616 extends to form the pin P2, the portion 617 extends to form the pin P3. A first part of the yoke 607 is wrapped around by the portions 613 and 614, and a second part of the yoke 607 is wrapped around by the portions 615 and 616, wherein the first part and the second part of the yoke 607 is separated by the center leg 606. The portions 615 and 618 are placed above a top surface of the yoke 607, and the pins P1-P4 are placed under a bottom surface of the yoke 607 which opposites the top surface of the yoke 607.

In the example of FIG. 7, each of the portion 615 and 618 has two straight parts (i.e., 611-1, 611-2 for the portion 615 and 612-1, 612-2 for the portion 618) parallel with each other, and two curved parts connecting the two straight parts respectively. The straight part 611-1 has an upper turn connecting the portion 613 and a lower turn connecting the portion 614. The straight part 612-1 has an upper turn connecting the portion 616 and a lower turn connecting the portion 617. The straight part 611-2 is stacked with the straight part 612-1, and the straight part 612-2 is stacked with the straight part 611-1. In the example shown in FIG. 7, each the straight part 611-1 and 612-1 has two turns, and each the straight part 611-2 and 612-2 has one turn. One with ordinary skill in the art should also understand that the turns numbers of the straight parts 611-1, 611-2, 612-1, and 612-2 are not limited by the example of FIG. 7, other numbers of turns may be employed.

In operation, the current i1 flows from the pin P1 to the pin P4 through the winding 611 as shown by solid lines with arrows, and the current i2 flows from the pin P2 to the pin P3 through the winding 612 as shown by dashed lines with arrows. In the coupled inductor assembly 600, the portion 615 and the portion 618 are over-lapped with each other to have inverse current flow.

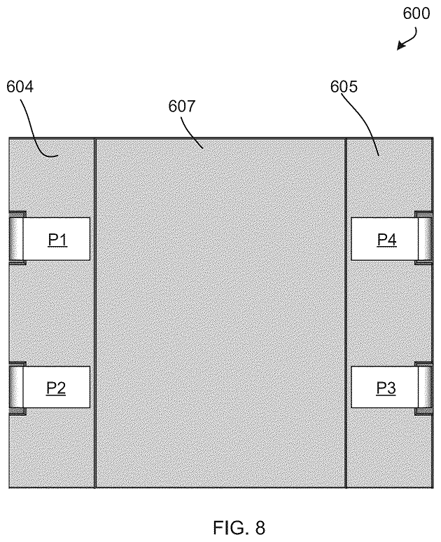

FIG. 8 shows a bottom view of the inductor assembly 600 of FIG. 6 in accordance with an embodiment of the present invention. In the example shown in FIG. 8, the yoke 607, and the outer legs 604-605 are extended to the bottom surface of the inductor assembly 600, and the yoke 607 is between the outer legs 604-605. In other embodiments, the bottom surface of the inductor assembly 600 is covered by the yoke 607, and the outer legs 604-605 are extended to the yoke 607, without exposed to the bottom surface of the inductor assembly 600. The four pins P1-P4 are arranged at the bottom surface of the inductor assembly 600. The pins P1 and P2 configured as current input pins are located at a first side of the bottom surface of the inductor assembly 600, and the pins P3 and P4 configured as current output pins are located at a second side of the bottom surface of the inductor assembly 600 which opposites the first side of the bottom surface of the inductor assembly 600.

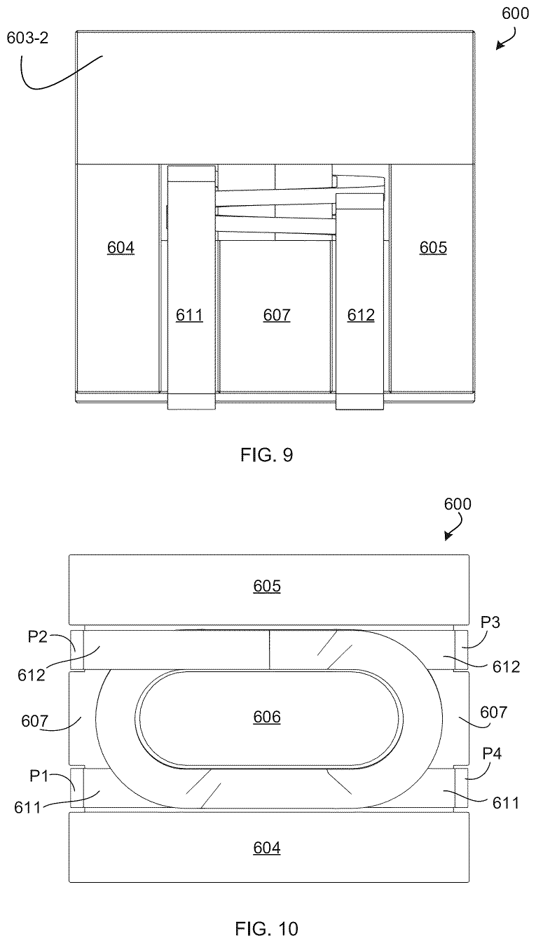

FIG. 9 shows a side view of the inductor assembly 600 of FIG. 6 in accordance with an embodiment of the present invention. As shown in the example of FIG. 9, a first portion of the yoke 607 exposes at the side of the inductor assembly 600, a second portion of the yoke 607 is covered by the winding 611, and a third portion of the yoke 607 is covered by the winding 612. The outer legs 604 and 605 expose at the side of the inductor assembly 600.

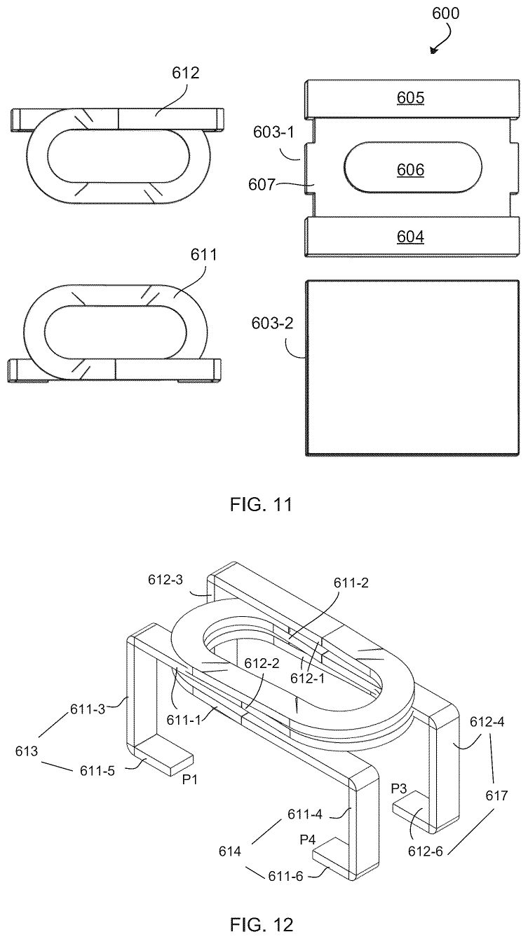

FIG. 10 shows a top and perspective view of the inductor assembly 600 of FIG. 6 in accordance with an embodiment of the present invention. As shown in FIG. 10, the windings 611 and 612 are partially over-lapped with each other around the center leg 606. FIG. 11 shows a top and disassembled view of the windings 611-612, the core parts 603-1 and 603-2 of the inductor assembly 600 of FIG. 6 in accordance with an embodiment of the present invention.

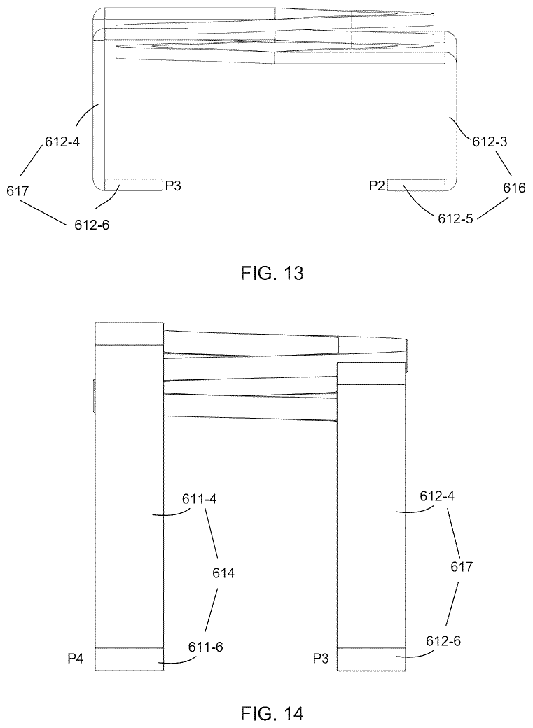

FIG. 12 shows the windings 611 and 612 in accordance with an embodiment of the present invention. FIGS. 13-14 show side views of the windings 611 and 612 of FIG. 12 in accordance with an embodiment of the present invention. As shown in FIGS. 12-14, the portion 613 of the winding 611 has a vertical part 611-3 and a horizontal part 611-5, the portion 614 of the winding 611 has a vertical part 611-4 and a horizontal part 611-6, the portion 616 of the winding 612 has a vertical part 612-3 and a horizontal part 612-5, the portion 617 of the winding 612 has a vertical part 612-4 ana a horizontal part 612-6. The vertical part 611-4 connects the horizontal part 611-6 and the straight part 611-1, and is perpendicular to the horizontal part 611-6, the straight part 611-1 and the bottom surface of the inductor assembly 600. The vertical part 611-3 connects the horizontal part 611-5 and the straight part 611-1, and is perpendicular to the horizontal part 611-5, the straight part 611-1, and the bottom surface of the inductor assembly 600. The vertical part 612-4 connects the horizontal part 612-6 and the straight part 612-1, and is perpendicular to the horizontal part 612-6, the straight part 612-1, and the bottom surface of the inductor assembly 600. The vertical part 612-3 connects the horizontal part 612-5 and the straight part 612-1, and is perpendicular to the horizontal part 612-5, the straight part 612-1 and the bottom surface of the inductor assembly 600. The straight parts 611-1, 611-2, 612-1, and 612-2 are parallel with the bottom surface of the inductor assembly 600.

The horizontal part 611-5 extends to form the pin P1, the horizontal part 611-6 extends to form the pin P4, the horizontal part 612-5 extends to form the pin P2, the horizontal part 612-6 extends to form the pin P3. In one embodiment, the pins P1-P4 are pads connected to the horizontal parts 611-5, 611-6, 612-5, 612-6 respectively. In another embodiment, the pins P1-P4 are at least partial of the horizontal parts 611-5, 611-6, 612-5, 612-6.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. An inductor assembly, comprising:
A first pin, a second pin, a third pin, and a fourth pin;
a magnetic core having a first core part, wherein the first core part has a center leg;
a first winding having a first portion, a second portion and a third portion, wherein the first portion extends to a first side of the inductor assembly to form the first pin, the second portion extends to a second side of the inductor assembly to form the fourth pin, wherein the second side opposites the first side; and
a second winding having a fourth portion, a fifth portion and a sixth portion, wherein the fourth portion extends to the first side of the inductor assembly to form the second pin, the fifth portion extends to the second side of the inductor assembly to form the third pin, the sixth portion is at least partially over-lapped with the third portion; wherein
the third portion and the sixth portion wrap around the center leg.

2. The inductor assembly of claim 1, wherein the first pin and the second pin are configured as current input pins, and the third pin and the fourth pin are configured as current output pins.

3. The inductor assembly of claim 1, wherein the first core part further has a first outer leg and a second outer leg, wherein the center leg is positioned between the first outer leg and the second outer leg.

4. The inductor assembly of claim 3, wherein the center leg is formed by a first material with a first saturation point, the first outer leg and the second outer leg are formed by a second material with a second saturation point which is higher than the first saturation point.

5. The inductor assembly of claim 3, wherein the first core part further has a yoke connecting the center leg with the first and the second outer legs, wherein a first part of the yoke is wrapped around by the first portion and the second portion, a second part of the yoke is wrapped around by the fourth portion, and the fifth portion.

6. The inductor assembly of claim 5, wherein the third portion and the sixth portion are placed above a top surface of the yoke, the first pin, the second pin, the third pin and the fourth pin are placed beneath a bottom surface of the yoke which opposites the top surface of the yoke.

7. The inductor assembly of claim 1, wherein each of the third portion and the sixth portion comprises at least a curved part.

8. The inductor assembly of claim 1, wherein the magnetic core further has a second core part faces towards the center leg.

9. The inductor assembly of claim 8, wherein the first core part has an E-shape, and the second core part has a planer shape or the E-shape.

10. The inductor assembly of claim 1, wherein each of the third portion and the sixth portion has a first straight part and a second straight part parallel with each other, the first straight part of the third portion has an first upper turn connecting the first portion and a first lower turn connecting the second portion, the first straight part of the sixth portion has a second upper turn connecting the fourth portion and a second lower turn connecting the fifth portion.

11. The inductor assembly of claim 10, wherein the second straight part of the third portion is stacked with the first straight part of the sixth portion, and the second straight part of the sixth portion is stacked with the first straight part of the third portion.

12. A switching converter, comprising:
a first pair of switches and a second pair of switches; and
an inductor assembly having a first input pin, a second input pin, a first output pin, and a second output pin, wherein the first input pin is coupled to a first switch node formed by the first pair of switches, and the second input pin is coupled to a second switch node formed by the second pair of switches; wherein
the inductor assembly comprises:
a first winding having a first portion, a second portion and a third portion, wherein the first portion extends to form the first input pin, the second portion extends to form the first output pin;
a second winding having a fourth portion, a fifth portion and a sixth portion, wherein the fourth portion extends to form the second input pin, the fifth portion extends to form the second output pin, the sixth portion is at least partially over-lapped with the third portion; and
a magnetic core having a center leg wrapped around by the third portion and the sixth portion.

13. The switching converter of claim 12, wherein the first input pin and the second input pin are at a first side of the inductor assembly, the first output pin and the second output pin are at a second side of the inductor assembly which opposites the first side of the inductor assembly.

14. The switching converter of claim 12, wherein the magnetic core further has a first outer leg and a second outer leg, wherein the center leg is positioned between the first outer leg and the second outer leg.

15. The switching converter of claim 14, wherein the center leg is formed by a first material with a first saturation point, the first outer leg and the second outer leg are formed by a second material with a second saturation point which is higher than the first saturation point.

16. The switching converter of claim 14, wherein the magnetic core further has a yoke connecting the center leg with the first and the second outer legs, wherein the third portion and the sixth portion are placed above a top surface of the yoke, the first input pin, the second input pin, the first output pin, and the second output pin are placed beneath a bottom surface of the yoke which opposites the top surface of the yoke.

17. The switching converter of claim 14, wherein the first winding and the second winding are configured to be reversely coupled to reduce a flux in the center leg.

18. The switching converter of claim 12, wherein each of the third portion and the sixth portion has a first straight part and a second straight part parallel with each other, the first straight part of the third portion has an first upper turn connecting the first portion and a first lower turn connecting the second portion, the first straight part of the sixth portion has a second upper turn connecting the fourth portion and a second lower turn connecting the fifth portion.

19. The switching converter of claim 18, wherein the second straight part of the third portion is stacked with the first straight part of the sixth portion, and the second straight part of the sixth portion is stacked with the first straight part of the third portion.

20. The switching converter of claim 18, wherein each of the second straight part of the third portion and the second straight part of the sixth portion has a single turn.
